(19) United States
(12) Patent Application Publication
(10) Pub. No.: US 2020/0020015 A1
(43) Pub. Date: Jan. 16, 2020

(54) ECOMMERCE PRODUCT-RECOMMENDATION ENGINE WITH RECIPIENT-BASED GIFT SELECTION

(71) Applicant: International Business Machines Corporation, Armonk, NY (US)

(72) Inventors: Kelley Anders, East New Market, MD (US); Jeremy R. Fox, Georgetown, TX (US); Lisa Seacat DeLuca, Baltimore, MD (US); Jeremy A. Greenberger, San Jose, CA (US)

(21) Appl. No.: 16/031,028

(22) Filed: Jul. 10, 2018

(51) Int. Cl. G06Q 30/06; G06Q 10/08; G06Q 50/00

(52) U.S. Cl. CPC G06Q 30/0631; G06Q 50/01; G06Q 10/083

(57) ABSTRACT

A product-recommendation engine of an ecommerce system receives notice that a potential online purchaser has selected an item as a gift for an online recipient user. The engine identifies characteristic patterns of the recipient based on the recipient's purchase history, gift-giving history, demographics, social-media postings, relationship with the purchaser, or other contextual information that may be retrieved or inferred through methods such as data-mining, artificial intelligence, online analytics, or pattern-matching. The engine then uses these patterns to select and recommend to the purchaser one or more alternate gifts that the recipient is likely to prefer over the purchaser's original choice. The engine then uses machine-learning to refine its selection procedure as a function of whether the purchaser accepts or rejects the recommendations.

### BACKGROUND

The present invention relates to ecommerce technology in general and, in particular to product-recommendation engines.

Ecommerce product-recommendation technology dates back to early 1990s research, such as the University of Minnesota's GroupLens Research Project, pioneering implementations by a handful of online retailers (most notably Amazon.com), and Web-authoring software vendor Net Perceptions.

Today's ubiquitous product-recommendation engines have grown enormously in complexity and sophistication. Today, virtually all large ecommerce systems incorporate recommendation technology, which may be implemented as a home-grown or a licensed third-party component of an ecommerce suite (such as a discrete module or an API), or may be purchased from a service provider as an extrinsic service. Vendors of product-recommendation applications and services include AgentArts, Inc., ChoiceStream, Inc., and Google/Alphabet, Inc., and major retailers that have made recommendation technology an essential component of their online ecommerce sites include Netflix, Amazon, eBay, and Apple Computer.

Known recommendation engines may combine artificial intelligence, machine-learning, data-mining, statistical analysis, online analytics, Bayesian probability, or other cognitive and non-cognitive methods to upsell an online consumer by selecting and recommending products that the consumer is likely to add to an existing order. These recommendations may occur while a consumer is still browsing or shopping at a seller's Web site, has begun to make an actual purchase, or at a time after a purchase has been made.

Examples of such recommendations include:
a “related items” recommendation that recommends products similar to a product that a consumer has previously viewed, purchased, searched for, or added to a cart. Related items might differ only in color, brand, condition, or age from the similar product, or they might be in different product classes. For example, a recommendation engine might, in response to a consumer's purchase of a berry-flavored soft drink, suggest a citrus-flavored offering in the same product line. In other examples, the engine might respond to a consumer's purchase of a streaming movie by recommending a related soundtrack album or a book. In some cases, more advanced product-recognition technologies may be used to determine that two products are “related,” such as by using visual pattern recognition technology to determine that two articles of clothing are related, or by using audio cues to relate musical selections;
a “frequently bought together” or “customers who bought this also bought” recommendation that recommends products that are often purchased by buyers who buy products similar to those that the consumer has viewed, purchased, searched for, or added to a cart; and
a “you might also be interested in” recommendation that recommends products that are known to be popular with buyers who share characteristics with the consumer. These recommendations may be generated by using a technology like data mining or pattern-matching to determine that a consumer's purchasing history, online behavior, demographic information, or other characteristics are similar to those of other users who purchase products similar to the recommended product.

Some recommendation engines may also base recommendations on a consumer's physical location. A seller may, for example, associate a consumer with a physical location: when the consumer uses a GPS-equipped device like as a smartphone, automobile, or tablet; if a user profile specifies an address or other location-identifying information; or if a consumer's physical location can be inferred by data-mining a consumer's historical data. In such cases, a recommendation engine may recommend that a consumer consider a venue in physical proximity to the consumer, for purposes like a shopping, dining, or sales consultation, or as a convenient pick-up location for an online order.

Known recommendation engines generally select a recommended product as a function of a characteristic of a buyer or potential buyer (such as the buyer's purchase history, shopping history, or demographic characteristics), or as a function of a characteristic of a product that is associated with the buyer, such as products that are similar to a buyer's past purchases, products similar to products that have been viewed by the buyer, or products that are popular with other users who share common characteristics with the buyer. When a user purchases a product as a gift for a recipient, known recommendation engines do not consider factors related to the recipient.

### SUMMARY

An embodiment of the present invention is a product-recommendation system comprising a processor, a memory coupled to the processor, and a computer-readable hardware storage device coupled to the processor, the storage device containing program code configured to be run by the processor via the memory to implement a method for recipient-based ecommerce product recommendation, the method comprising:

the processor receiving notice that an online purchaser has selected an initial item to purchase;

the processor inferring that the initial item to purchase is a gift for an online recipient;

the processor associating the online recipient with an alternate item; and

the processor recommending to the online purchaser that the online purchaser gift the alternate item to the online recipient.

Another embodiment of the present invention is a method for recipient-based ecommerce product recommendation, the method comprising:

a processor of a product-recommendation system receiving notice that an online purchaser has selected an initial item to purchase;

the processor inferring that the initial item to purchase is a gift for an online recipient;

the processor associating the online recipient with an alternate item; and

the processor recommending to the online purchaser that the online purchaser gift the alternate item o the online recipient.

Yet another embodiment of the present invention is a computer program product, comprising a computer-readable hardware storage device having a computer-readable program code stored therein, the program code configured to be executed by a product-recommendation system comprising a processor, a memory coupled to the processor, and a computer-readable hardware storage device coupled to the processor, the storage device containing program code configured to be run by the processor via the memory to implement a method for recipient-based ecommerce product recommendation, the method comprising:

a processor of a product-recommendation system receiving notice that an online purchaser has selected an initial item to purchase;

the processor inferring that the initial item to purchase is a gift for an online recipient;

the processor associating the online recipient with an alternate item; and

the processor recommending to the online purchaser that the online purchaser gift the alternate item to the online recipient.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 shows the structure of a computer system and computer program code that may be used to implement a method for recipient-based ecommerce product recommendation in accordance with embodiments of the present invention.

FIG. 4 is a flow chart that illustrates steps of a method for recipient-based ecommerce product recommendation in accordance with embodiments of the present invention.

### DETAILED DESCRIPTION

Since its inception in the 1990s, product-recommendation technology has become a key component of ecommerce systems. The ability of a recommendation engine to select and recommend products tailored to an online consumer's personal preferences is as valuable to an online merchant as is an upselling salesman to a bricks-and-mortar retailer.

Modern recommendation engines are implemented as applications and services that may use cognitive or non-cognitive mechanisms to identify products that are likely to be attractive to a particular purchaser. Recommendation engines can, for example, identify products that have personal relevance to a specific consumer, that are generally popular with buyers who share common characteristic with the purchaser, or that are often bought together with an already-purchased product.

All of these criteria are functions of characteristics of the purchaser, or of an item selected by the purchaser. When an item is purchased as a gift, however, characteristics of the recipient should be at least as important as those of the purchaser. Yet recommendation engines lack the ability to distinguish between an item purchased for direct use by the purchaser and an item purchased for use by a gift recipient. And even if existing product-recommendation technology was capable of identifying a gift purchase, current recommendation engines are not able to consider characteristics of a recipient when recommending an additional product.

Embodiments of the present invention improve current product-recommendation technology by adding features that allow a recommendation engine to: i) determine a likelihood that a purchased item is a gift; ii) identify the recipient of such a gift; and iii) make an additional product recommendation as a function of characteristics of the recipient, rather than by solely considering characteristics of the purchaser.

These improvements do not exist in the current state of the art of product-recommendation technology, and thus are not well-understood, conventional, or routine in the field. Instead, they constitute a technical improvement to a technical problem of an existing computerized technology, because the architecture and design of current product-recommendation engines do not allow those engines to identify and analyze characteristics of online gift recipients.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

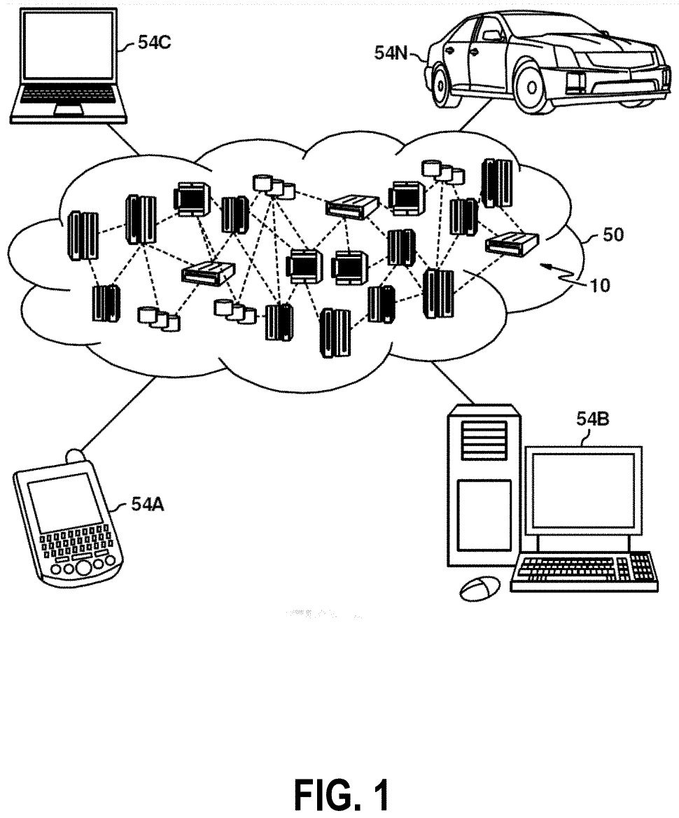

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

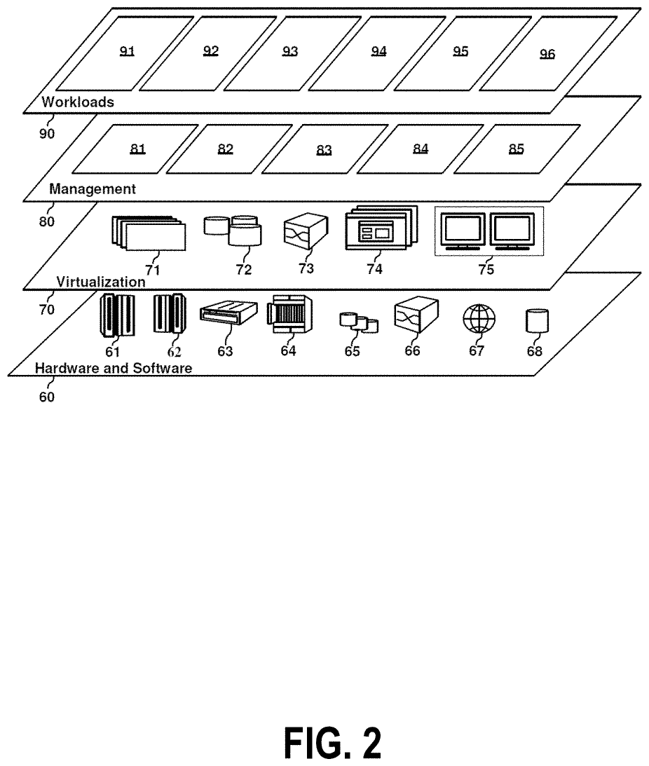

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which e cloud computing environment may be utilized. Examples of workloads and functions which may be provided from this layer include: mapping and navigation 91; software development and lifecycle management 92; virtual classroom education delivery 93; data analytics processing transaction processing 95; and orchestration of ecommerce product recommendations with recipient-based gift selection.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which cute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

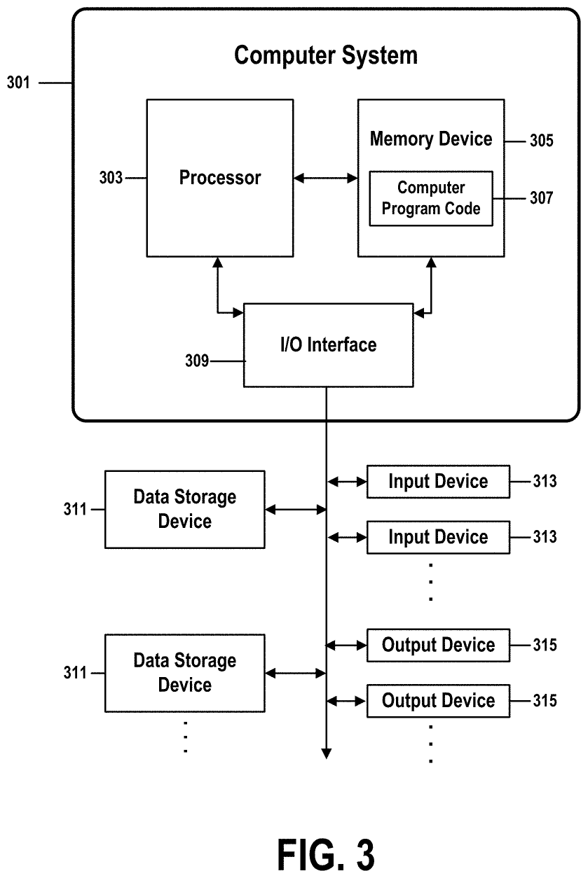

FIG. 3 shows a structure of a computer system and computer program code that may be used to implement a method for recipient-based ecommerce product recommendation in accordance with embodiments of the present invention. FIG. 3 refers to objects 301-315.

In FIG. 3, computer system 301 comprises a processor 303 coupled through one or more I/O Interfaces 309 to one or more hardware data storage devices 311 and one or more I/O devices 313 and 315.

Hardware data storage devices 311 may include, but are not limited to, magnetic tape drives, fixed or removable hard disks, optical discs, storage-equipped mobile devices, and solid-state random-access or read-only storage devices. I/O devices may comprise, but are not limited to: input devices 313, such as keyboards, scanners, handheld telecommunications devices, touch-sensitive displays, tablets, biometric readers, joysticks, trackballs, or computer mice; and output devices 315, which may comprise, but are not limited to printers, plotters, tablets, mobile telephones, displays, or sound-producing devices. Data storage devices 311, input devices 313, and output devices 315 may be located either locally or at remote sites from which they are connected to I/O Interface 309 through a network interface.

Processor 303 may also be connected to one or more memory devices 305, which may include, but are not limited to, Dynamic RAM (DRAM), Static RAM (SRAM), Programmable Read-Only Memory (PROM), Field-Programmable Gate Arrays (FPGA) Secure Digital memory cards, SIM cards, or other types of memory devices.

At least one memory device 305 contains stored computer program code 307, which is a computer program that comprises computer-executable instructions. The stored computer program code includes a program that implements a method for recipient-based ecommerce product recommendation in accordance with embodiments of the present invention, and may implement other embodiments described in this specification, including the methods illustrated in FIGS. 1-4. The data storage devices 311 may store the computer program 307. Computer program code 307 stored in the storage devices 311 is configured to be executed by processor 303 via the memory devices 305. Processor 303 executes the stored computer program code 307.

In some embodiments, rather than being stored and accessed from a hard drive, optical disc or other writeable, rewriteable, or removable hardware data-storage device 311, stored computer program code 307 may be stored on a static, nonremovable, read-only storage medium such as a Read-Only Memory (ROM) device 305, or may be accessed by processor 303 directly from such a static, nonremovable, read-only medium 305. Similarly, in some embodiments, stored computer program code 307 may be stored as computer-readable firmware 305, or may be accessed by processor 303 directly from such firmware 305, rather than from a more dynamic or removable hardware data-storage device 311, such as a hard drive or optical disc.

Thus the present invention discloses a process for supporting computer infrastructure, integrating, hosting, maintaining, and deploying computer-readable code into the computer system 301, wherein the code in combination with the computer system 301 is capable of performing a method for recipient-based ecommerce product recommendation.

Any of the components of the present invention could be created, integrated, hosted, maintained, deployed, managed, serviced, supported, etc. by a service provider who offers to facilitate a method for recipient-based ecommerce product recommendation. Thus the present invention discloses a process for deploying or integrating computing infrastructure, comprising integrating computer-readable code into the computer system 301, wherein the code in combination with the computer system 301 is capable of performing a method for recipient-based ecommerce product recommendation.

One or more data storage units 311 (or one or more additional memory devices not shown in FIG. 3) may be used as a computer-readable hardware storage device having a computer-readable program embodied therein and/or having other data stored therein, wherein the computer-readable program comprises stored computer program code 307. Generally, a computer program product (or, alternatively, an article of manufacture) of computer system 301 may comprise the computer-readable hardware storage device.

In embodiments that comprise components of a networked computing infrastructure, a cloud-computing environment, a client-server architecture, or other types of distributed platforms, functionality of the present invention may be implemented solely on a client or user device, may be implemented solely on a remote server or as a service of a cloud-computing platform, or may be split between local and remote components.

While it is understood that program code 307 for a method for recipient-based ecommerce product recommendation may be deployed by manually loading the program code 307 directly into client, server, and proxy computers (not shown) by loading the program code 307 into a computer-readable storage medium (e.g., computer data storage device 311), program code 307 may also be automatically or semi-automatically deployed into computer system 301 by sending program code 307 to a central server (e.g., computer system 301) or to a group of central servers. Program code 307 may then be downloaded into client computers (not shown) that will execute program code 307.

Alternatively, program code 307 may be sent directly to the client computer via e-mail. Program code 307 may then either be detached to a directory on the client computer or loaded into a directory on the client computer by an e-mail option that selects a program that detaches program code 307 into the directory.

Another alternative is to send program code 307 directly to a directory on the client computer hard drive. If proxy servers are configured, the process selects the proxy server code, determines on which computers to place the proxy servers' code, transmits the proxy server code, and then installs the proxy server code on the proxy computer. Program code 307 is then transmitted to the proxy server and stored on the proxy server.

In one embodiment, program code 307 for a method for recipient-based ecommerce product recommendation is integrated into a client, server and network environment by providing for program code 307 to coexist with software applications (not shown), operating systems (not shown) and network operating systems software (not shown) and then installing program code 307 on the clients and servers in the environment where program code 307 will function.

The first step of the aforementioned integration of code included in program code 307 is to identify any software on the clients and servers, including the network operating system (not shown), where program code 307 will be deployed that are required by program code 307 or that work in conjunction with program code 307. This identified software includes the network operating system, where the network operating system comprises software that enhances a basic operating system by adding networking features. Next, the software applications and version numbers are identified and compared to a list of software applications and correct version numbers that have been tested to work with program code 307. A software application that is missing or that does not match a correct version number is upgraded to the correct version.

A program instruction that passes parameters from program code 307 to a software application is checked to ensure that the instruction's parameter list matches a parameter list required by the program code 307. Conversely, a parameter passed by the software application to program code 307 is checked to ensure that the parameter matches a parameter required by program code 307. The client and server operating systems, including the network operating systems, are identified and compared to a list of operating systems, version numbers, and network software programs that have been tested to work with program code 307. An operating system, version number, or network software program that does not match an entry of the list of tested operating systems and version numbers is upgraded to the listed level on the client computers and upgraded to the listed level on the server computers.

After ensuring that the software, where program code 307 is to be deployed, is at a correct version level that has been tested to work with program code 307, the integration is completed by installing program code 307 on the clients and servers.

Embodiments of the present invention may be implemented as a method performed by a processor of a computer system, as a computer program product, as a computer system, or as a processor-performed process or service for supporting computer infrastructure.

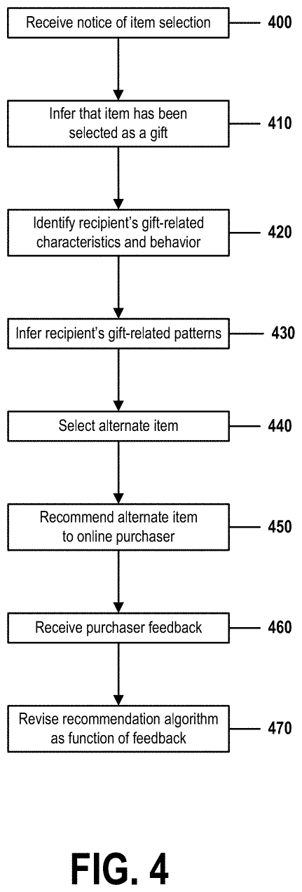

FIG. 4 is a flow chart that illustrates the steps of a method for recipient-based ecommerce product recommendation in accordance with embodiments of the present invention. FIG. 4 contains steps 400-470.

In step 400, a product-recommendation module, system, or service (referred to below as a “processor”) receives notice that a “consumer” or “purchaser” user of an ecommerce system has viewed, selected, browsed, added to a shopping cart, or otherwise taken steps aimed at purchasing a product or service that has been offered for sale by the ecommerce system. The product-recommendation module or service may be integrated into the ecommerce system or may be implemented as a standalone technology that provides recommendation services to the ecommerce system through known means, such as by means of API calls, through a network interface, or by communicating with a hosted cloud service.

The notice may be received by any means known in the art, such as through internal communications between modules of an ecommerce architecture, through the Internet, through API or system calls, or through a messaging function of a hypervisor.

In step 410, the processor determines that the consumer intends the product or service to become a gift for a recipient user. This determination may be made by identifying any activity or decision of the purchaser that may be associated with selecting a gift and with identifying the recipient. For example, the processor may receive notice from the ecommerce system that a potential purchaser had initially selected the product from an online gift registry of the recipient, has selected gift options for a product in the consumer's ecommerce shopping cart, has designated a shipping address for a product that differs from the purchaser's own address, or has specified that an order of streaming content or an online service should be delivered to a certain username on a social-network service.

In step 420, the processor identifies characteristics or behavior of the online recipient identified in step 410. This identification step may be accomplished by any means known in the art, such as by data-mining recipient data stored in the ecommerce system's user profile or online activity log, or by tracking the recipient's online behavior on other ecommerce sites or on a social-media service.

For example, the processor in this step might determine whether the recipient:
has received a product or service in the past that is identical to or similar to the item identified by the online consumer;
has received a product or service in the past from the online consumer;
has received a product or service in the past from the online consumer that is identical to or similar to the item identified by the online consumer;
has purchased a product or service in the past that is identical to or similar to the item identified by the online consumer;
has purchased as a gift a product or service in the past that is identical to or similar to the item identified by the online consumer;
has made an online posting specifying a preference (or lack of preference) for specific types of products or services, such as leaving “Like” feedback on a product page, on a company page, or on another user's postage message complimenting or disparaging a particular product or company; or
has made an online posting identifying an event that is relevant to a gift-giving occasion or to a specific type of gift. Examples of such events may comprise a party, a birthday, a marriage, an engagement, a holiday, a graduation, a promotion, a bereavement, or a vacation. For example, if a recipient posts an announcement of a funeral on a social-media site, this announcement may suggest a gift to the recipient of a flower arrangement or of a donation to a charitable cause. Similarly, a recipient who has logged significant recent activity on a Caribbean-cruise pages of a travel Web site or who has recently booked such a cruise might generate an inference that the recipient might have use for a gift certificate from a beachwear retailer. In yet another example, a relationship among a group of purchasers and recipients may be inferred from that group's ongoing discussions of their impending wedding plans on a social-network site.

Some embodiments may allow the processor to proceed only if the recipient identified in this step belongs to a certain group. In some cases, an embodiment might allow a purchaser/consumer to limit applications of the present invention's recommendation engine to be enabled only for certain recipients, such as a group of wedding guests or members of a high-school graduating class.

In some embodiments, some of the identified recipient data might comprise information describing joint patterns based on interactions between the recipient and the consumer, or between the recipient and other online users who have purchased gifts for the recipient in the past. In all cases, however, raw data identified in this step comprise at least some relation to the recipient.

In step 430, the processor infers, from the information identified in step 420, gift-related patterns associated with the recipient. These inferences may be performed by any combination of means known in the art, such as by pattern-matching, text analytics, semantic analytics, statistical methods, artificial intelligence, Bayesian analysis, machine learning, or keyword searching.

In some embodiments, the system might augment these inferred recipient-only patterns with supplemental patterns based on information about interactions or relationships between the recipient and the consumer, or about interactions or relationships between the recipient and other online users who have purchased gifts for the recipient in the past.

In one example, the processor may identify that the consumer has a pattern of gifting to the recipient a one-year subscription to a particular magazine every year on the anniversary of the consumer's hiring of the recipient as an employee. In another case, the consumer might have a pattern of presenting to the recipient, on every February 14, a romantic gift, in the range of $20-$30.

Other patterns might indicate that the recipient prefers, or is exclusively committed to, a certain brand, a certain product configuration, or a certain type of packaging. A pattern might indicate, for example, that a recipient prefers to buy, or to receive, certain commodity items in 30-day or 90-day supplies, or that the recipient prefers leisurewear in certain colors, sizes, or patterns, prefers certain styles of shoes, or has frequently purchased gift cards for other users at two particular restaurants or health spas. A recipient might have a personal shopping pattern of reviewing a variety of products in a certain product category, but then always selecting the lowest-priced generic product in that category.

This list of examples should not be construed to limit embodiments of the present invention to only certain types of patterns. The present invention is flexible enough to accommodate any type of pattern that may be identified or inferred by known analytical methods. In more sophisticated examples, the system may infer that the recipient prefers “socially responsible” products as a function of the recipient's online browsing, news-reading, or purchasing history, or may infer that the recipient would not be interested in physically demanding vacations because the recipient's gifting history indicates that a close family member may be physically unable to participate in such a vacation. In yet another case, the system may infer that the recipient prefers certain audio or video content in certain entertainment genres as a function of the recipient's online subscriptions to genre-specific publications or services, as a function of a log indicating that the recipient has “Liked” or “Followed” certain entertainers, actors, authors, or musicians on social-media sites or blogs.

Other patterns may further consider extrinsic factors. For example, if online users in a particular demographic tend to buy a certain type of content from streaming services, rather than from download services, the system may infer that, because the recipient shares that particular demographic, the recipient would likewise prefer to consume that type of content, or would prefer to consume that type of content only in streaming form. If a national holiday is known to be occurring shortly after the consumer's potential purchase, and if the recipient's history indicates a pattern of observing that holiday in the past, the system might infer that the recipient is likely to prefer gifts associated with that holiday, such as receiving a patriotically themed gift shortly before Independence Day.

In other cases, it may be known from Internet-wide online-analytics services, or from generally accepted precepts of a particular field of commerce or technology, that people who buy a certain item are likely to purchase a second type of item. For example, the system may infer that, if the recipient receives an e-book reader, that the recipient may be likely to concurrently or subsequently purchase one or more electronic magazine subscriptions. Similarly, it may be known that users within the recipient's age group who receive a gift of a tablet device are likely to purchase a popular computer application for that tablet.

Many other possible patterns may be inferred by various embodiments of the present invention, using any combination of inferential or logical algorithms and information sources known in the art.

In step 440, the processor selects one or more alternate gift items as a function of the patterns inferred in step 430. These selection may be a function of a combination of multiple inferences and may be made by any logical, inferential, artificially intelligent, statistical, or other mechanism known in the art.

For example, if the consumer in step 400 selected a gift of a blue sweatshirt in an XL size, and if the system in steps 420 and 430 identified that the recipient's favorite color is dark red and shirt size is M, then the system in step 440 may identify an alternate gift of a similar sweatshirt in a different color and size.

Similarly, if the consumer in step 400 selected a gift of a floor-standing lamp, and if the system in steps 420 and 430 identified that the recipient has a history of purchasing home-automation devices, then the system in step 440 may identify an alternate gift of a wireless smartphone-based lighting controller capable of being used with the lamp.

In yet other examples, the processor may select an alternative item that is completely different from the product or service originally selected by the consumer. For example, if the processor determines that the recipient has recently sustained an injury that temporarily limits the recipient's mobility, the processor may select an alternative gift of a streaming-movie subscription as a replacement for an originally selected gift of a bicycle.

In step 450, the processor recommends to the purchaser the alternate gift item identified in step 440. This recommendation may recommend the alternate as a replacement for the product originally selected by the purchaser or as an additional product to be added by the purchaser to a current order. In some cases, the system may allow the purchaser to select whether the alternative item should replace or complement the previously selected product.

In some embodiments, the system may recommend multiple alternatives. In such cases, the processor may allow the purchaser to select a subset of the alternatives. In other embodiments, the system may allow the purchaser to solicit an opinion from the recipient or from third-party users about whether an alternative gift should be selected as a replacement or complement to the originally selected product, or about which subset of a set of multiple alternatives would be most appropriate.

In other embodiments, a user may be allowed more granular control over recommendations. For example, a user may allow recommendations to be made only for kitchen appliances, not for articles of clothing, and in some cases, these recommendations may even be tailored to specific recipients.

The system may also in this step provide additional information about the recommended products or services, such as a text description, specifications, pricing options, availability dates, shipping costs, or links to a manufacturer or product-information page. In particular, the processor may expressly communicate to the purchaser that: i) the processor has determined that the purchaser's original selection is intended to be given to the recipient as a gift; ii) one or more behaviors or characteristics of the recipient, or other characteristic or factor related to the recipient, the initially selected item, or the purchaser suggests that the recipient would prefer to receive as a gift an alternative item recommended by the processor.

In step 460, the processor receives feedback from the consumer/purchaser indicating the consumer's final purchase decision and response to the recommendation of step 450. This feedback may be received by any means known in the art, such as via email, text message, or internal communications mechanisms of the ecommerce system.

The received feedback may comprise, for example, a decision to replace the originally selected purchase with one or more of the alternative gifts, to add one or more of the alternative gifts to the current order in progress, or to reject all recommended gifts. In some cases, the feedback may specify that one or more of the alternative gifts be saved in a wish list, favorites list, or other repository, regardless of whether the recommended gifts are purchased at the time.

Other types of feedback may be possible, such as a request for more information, a request for more product recommendations, or a request for specific recommendations of items similar in some way or different in some way from the recommended items. For example, if the system in step 450 recommended several bicycles in the $150-$200 range, the purchaser in this step might request additional recommendations for bicycles that cost less than $100.

If the consumer makes a final purchase at this point, the processor might receive further feedback indicating which recommendation, if any, was embraced by the consumer, and whether the originally selected product was purchased along with a recommended product.

In step 470, the system may revise its product-selection procedure of steps 410-440 as a function of the feedback received in step 460. For example, if the consumer rejected a recommendation of a particular computer game, the system might assign a lower weight to future identifications of that game as an alternative gift recommendation, as a recommendation when a consumer has selected an initial product similar to the product selected in this case, or as a recommendation for recipients who share demographic or behavioral characteristics with the current recipient.

In some cases, characteristics of the consumer/purchaser, or a relationship between the recipient and the consumer/purchaser may also be considered when making such revisions. For example, the processor may revise the relative weightings of romantic, practical, and humorous birthday gifts based on an inference of whether the purchaser and recipient are more likely to be related as siblings, co-workers, or spouses.

These revisions may be performed by any means known in the art for revising inferential, pattern-matching, machine-learning, or other types of self-adjusting computerized decision-making mechanisms.

The processor may, throughout steps of the method of FIG. 4, communicate with other components of the ecommerce system. The processor may, for example, request and receive recipient, product, or consumer information from the ecommerce system in step 410, and may return elements of its identified recipient characteristics or pattern identifications to the ecommerce system for fixture storage and analysis. The processor may intercept elements of the ecommerce system's product-ordering procedure in order to communicate alternate-product recommendations to the purchaser, or may request and receive notice of the purchaser's final item selection from the ecommerce system.

The processor may exchange information with other elements of the ecommerce system in other ways, depending on implementation, such as by instructing the ecommerce system to reply to a user request for more product information instep 460. This close coupling is a function of the fact that the present invention, an improved product-recommendation engine, whether implemented as a software module, an API, a distinct application, or cloud service, is a functional element of an ecommerce system, and represents an improvement both to existing product-recommendation technology and to ecommerce technology itself.

Examples and embodiments of the present invention described in this document have been presented for illustrative purposes. They should not be construed to be exhaustive nor limit embodiments of the present invention to the examples and embodiments described here. Many other modifications and variations of the present invention that do not depart from the scope and spirit of these examples and embodiments will be apparent to those possessed of ordinary skill in the art. The terminology used in this document was chosen to best explain the principles underlying these examples and embodiments, in order to illustrate practical applications and technical improvements of the present invention over known technologies and products, and to enable readers of ordinary skill in the art to better understand the examples and embodiments disclosed here.

What is claimed is:

1. A product-recommendation system comprising a processor, a memory coupled to the processor, and a computer-readable hardware storage device coupled to the processor, the storage device containing program code configured to be run by the processor via the memory to implement a method for recipient-based ecommerce product recommendation, the method comprising:
the processor receiving notice that an online purchaser has selected an initial item to purchase;
the processor inferring that the initial item to purchase is a gift for an online recipient;
the processor associating the online recipient with an alternate item,
where the associating comprises inferring a pattern in the online recipient's prior product-selection behavior, and
where the pattern indicates a preference for products that share a common characteristic; and
the processor recommending to the online purchaser that the online purchaser gift the alternate item to the online recipient, where the recommending communicates to the online purchaser that a past behavior of the online recipient suggests that the online recipient will prefer to receive the alternate item, rather than the initial item, as a gift.

2. The system of claim 1, where the processor infers that the initial item to purchase is a gift by determining that the item is to be shipped to an address that is distinct from a physical address of the online purchaser.

3. The system of claim 1, where the processor infers that the initial item to purchase is a gift as a function of previous gift purchases made by the online purchaser.

4. The system of claim I, where the processor infers that the initial item to purchase is a gift because the online purchaser has chosen the initial item from a gift registry.

5. The system of claim 1, where the associating comprises identifying a relationship between the online purchaser and the online recipient.

6. The system of claim 1, where the associating comprises determining that the online recipient has previously gifted the alternate item to other online users.

7. The system of claim 1, where the associating comprises determining that the online recipient has in the past received the alternate item as a gift.

8. The system of claim 1, where the associating comprises inferring, from a social-media posting of the online recipient, context for a gifting of the alternate item by the online purchaser to the online recipient.

9. A method for recipient-based ecommerce product recommendation, the method comprising:
a processor of a product-recommendation system receiving notice that an online purchaser has selected an initial item to purchase;
the processor inferring that the initial item to purchase is a gift for an online recipient;
the processor associating the online recipient with an alternate item,
where the associating comprises inferring a pattern in the online recipient's prior product-selection behavior, and
where the pattern indicates a preference for products that share a common characteristic; and
the processor recommending to the online purchaser that the online purchaser gift the alternate item to the online recipient, where the recommending communicates to the online purchaser that a past behavior of the online recipient suggests that the online recipient will prefer to receive the alternate item, rather than the initial item, as a gift.

10. The method of claim 9, where the processor infers that the initial item to purchase is a gift by determining that the item is to be shipped to an address that is distinct from a physical address of the online purchaser.

11. The method of claim 9, where the associating comprises identifying a relationship between the online purchaser and the online recipient.

12. The method of claim 9, where the associating comprises determining that the online recipient has previously gifted the alternate item other online users.

13. The method of claim 9, where the associating comprises determining that the online recipient has in the past received the alternate item as a gift.

14. The method of claim 9, where the associating comprises inferring, from a social-media posting of the online recipient, context for a gifting of the alternate item by the online purchaser to the online recipient.

15. The method of claim 9, further comprising providing at least one support service for at least one of creating, integrating, hosting, maintaining, and deploying computer-readable program code in the computer system, wherein the computer-readable program code in combination with the computer system is configured to implement the receiving, the inferring, the associating, and the recommending.

16. A computer program product, comprising a computer-readable hardware storage device having a computer-readable program code stored therein, the program code configured to be executed by a product-recommendation system comprising a processor, a memory coupled to the processor, and a computer-readable hardware storage device coupled to the processor, the storage device containing program code configured to be run by the processor via the memory to implement a method for recipient-based ecommerce product recommendation, the method comprising:
a processor of a product-recommendation system receiving notice that an online purchaser has selected an initial item to purchase;
the processor inferring that the initial item to purchase is a gift for an online recipient;
the processor associating the online recipient with an alternate item,
where the associating comprises inferring a pattern in the online recipient's prior product-selection behavior, and
where the pattern indicates a preference for products that share a common characteristic; and
the processor recommending to the online purchaser that the online purchaser gift the alternate item to the online recipient, where the recommending communicates to the online purchaser that a past behavior of the online recipient suggests that the online recipient will prefer to receive the alternate item, rather than the initial item, as a gift.

17. The computer program product of claim 16, where the processor infers that the initial item to purchase is a gift by determining that the item is to be shipped to an address that is distinct from a physical address of the online purchaser.

18. The computer program product of claim 16, where the associating comprises identifying a relationship between the online purchaser and the online recipient.

19. The computer program product of claim 16, where the associating comprises determining that the online recipient has previously gifted the alternate item to other online users or has in the past received the alternate item as a gift.

20. The computer program product of claim 16, where the associating comprises inferring, from a social-media posting of the online recipient, context for a gifting of the alternate item by the online purchaser to the online recipient.
